(19) United States
(12) Patent Application Publication
(10) Pub. No.: US 2025/0383669 A1
(43) Pub. Date: Dec. 18, 2025

(54) Robotic Dogs and Animal-Like Robots with Embodied Artificial Intelligence

(71) Applicant: General Cybernation Group Inc., Rancho Cordova, CA (US)

(72) Inventors: George Shu-Xing Cheng, Folsom, CA (US); Andrew J. Chow, Sacramento, CA (US)

(73) Assignee: General Cybernation Group Inc., Rancho Cordova, CA (US)

(21) Appl. No.: 18/742,727

(22) Filed: Jun. 13, 2024

(51) Int. Cl. G05D 1/648; G05D 1/248; G05D 1/622; G05D 101/10; G05D 105/85; G05D 109/12; G05D 111/10; G05D 111/20; G05D 111/30

(52) U.S. Cl. CPC G05D 1/648; G05D 1/248; G05D 1/622; G05D 2101/10; G05D 2105/85; G05D 2109/12; G05D 2111/14; G05D 2111/20; G05D 2111/30

(57) ABSTRACT

A robotic dog empowered by generative artificial intelligence (Gen-AI) is disclosed, capable of autonomously performing essential tasks such as guiding visually impaired individuals, detecting drugs and arms, and providing companionship. The robotic dog's lifelike design includes a head, eyes, ears, a nose, a mouth with teeth, a neck, a body, four legs with paws, and a tail, all meticulously crafted to mimic the appearance and behavior of a real dog. A trained AI model functions as the brain, processing environmental data captured by video cameras, audio microphones, and sensors to provide guidance commands to a control system that control the movements of the robotic dog. A well-trained live dog can serve as a teacher for one or multiple robotic dogs using a generative AI-based real-time training method, enabling efficient and effective training of robotic dogs.

### INVENTION

The subject of this patent relates to embodied artificial intelligence, robotic dogs, animal-like robots, and guidance and control.

An animal-like robot is an advanced machine designed to resemble and mimic the structure and functionality of animals including dogs and cats. These robots typically include the following key components:

Head: A head with features that mimic the animal's facial structure, potentially including movable parts such as ears and mouth for realistic expressions.

Eyes: Multiple eyes equipped with cameras and other sensors to capture visual data and enable vision-based tasks and navigation.

Mouth and Teeth: A mouth with teeth to mimic the appearance and functions of the animal, such as gripping or interacting with objects.

Ears: Multiple ears equipped with microphones and other sensors to capture audio data and contribute to the robot's realistic appearance.

Nose: A nose equipped with sensors to detect smells and enhance the robot's environmental awareness.

Neck: A neck connects the head to the body and provides flexibility and movement.

Body Structure: A body designed to resemble the shape and form of a specific animal, providing the framework to house and connect all robotic components.

Limbs: A set of legs (four for dogs and cats) with joints and actuators to replicate the movement and agility of the animal, allowing for walking, running, and other motions.

Tail: A tail equipped with actuators to mimic the movements of the animal's tail, contributing to balance and expression.

Sensors: A variety of sensors to capture environmental data, including: (i) video cameras for visual input, (ii) audio microphones for sound detection, (iii) tactile sensors to sense touch and pressure, (iv) environmental sensors to measure temperature, humidity, and other conditions.

Control Systems: The “brain” of the robot, consisting of processors and software that interpret sensor data and control the actuators. Advanced control systems incorporate algorithms for motion dynamics, decision-making, and interaction with the environment. Embodied artificial intelligence enables the robot to learn from its experiences and adapt to new situations.

Power Supply: This component provides the necessary energy for the robot's operation. Power supplies include flexible thin film solar panels and batteries. In addition, a wireless battery charging mechanism is included in the power supply system.

Communication Interfaces: These allow the robot to interact with other systems and humans, using wireless or wired communication technologies. Effective communication interfaces are essential for remote control, monitoring, and data exchange.

Together, these components enable animal-like robots to perform a wide range of tasks, from providing companionship and assistance to individuals, to performing security and surveillance operations, search and rescue missions, and engaging in therapeutic and educational activities. These robots can also be employed in industrial settings for inspection and maintenance, in healthcare for patient monitoring, and in agricultural environments for herding and monitoring livestock. Additionally, animal-like robots can be utilized in defense and security roles, such as patrolling and monitoring sensitive areas, detecting and neutralizing threats, and supporting military operations with reconnaissance and intelligence gathering.

The advancement of large language models (LLM) and generative artificial intelligence (Gen-AI) makes it feasible to train animal-like robots to perform various tasks using videos, images, and text. In this patent, we describe innovative animal-like robots with embodied artificial intelligence.

In the accompanying drawings:

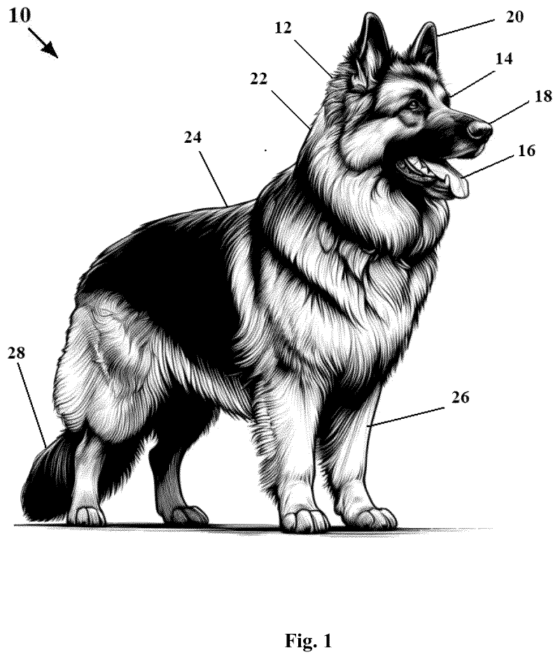

FIG. 1 is a perspective front view of robotic dog with all key components, according to an embodiment of this invention.

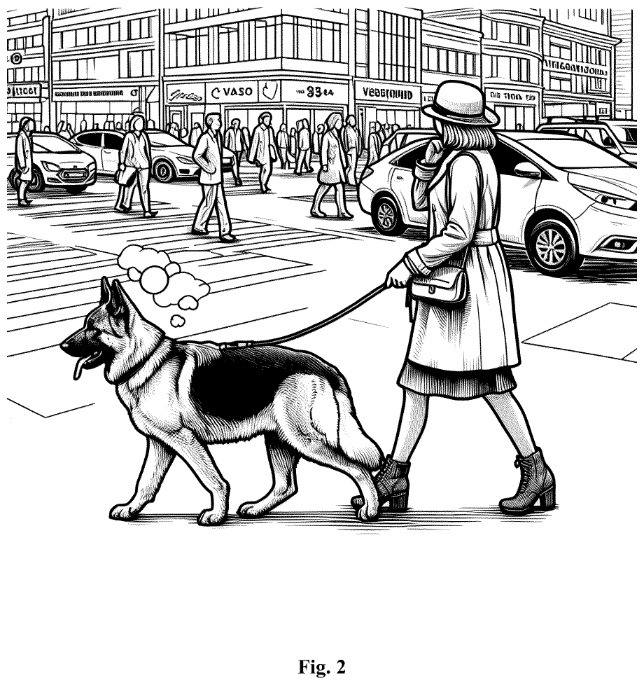

FIG. 2 is a perspective view of a robotic dog working as a service dog to lead a visually impaired person to walk across a busy street, according to an embodiment of this invention.

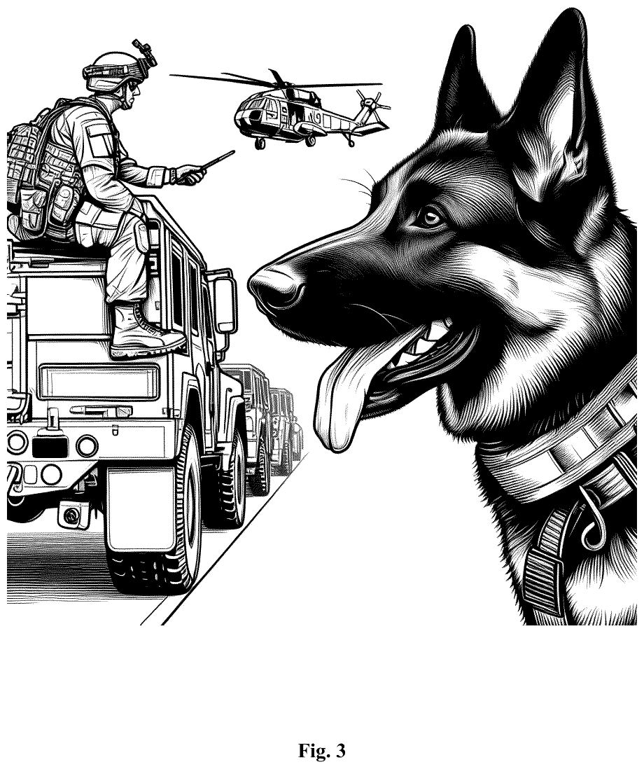

FIG. 3 is a perspective view of a robotic dog supporting defense operations, according to an embodiment of this invention.

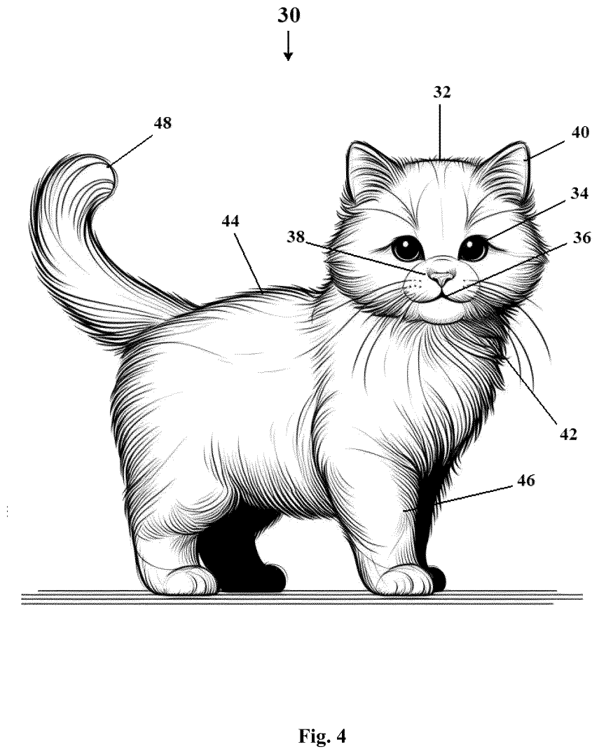

FIG. 4 is a perspective front view of robotic cat with all key components, according to an embodiment of this invention.

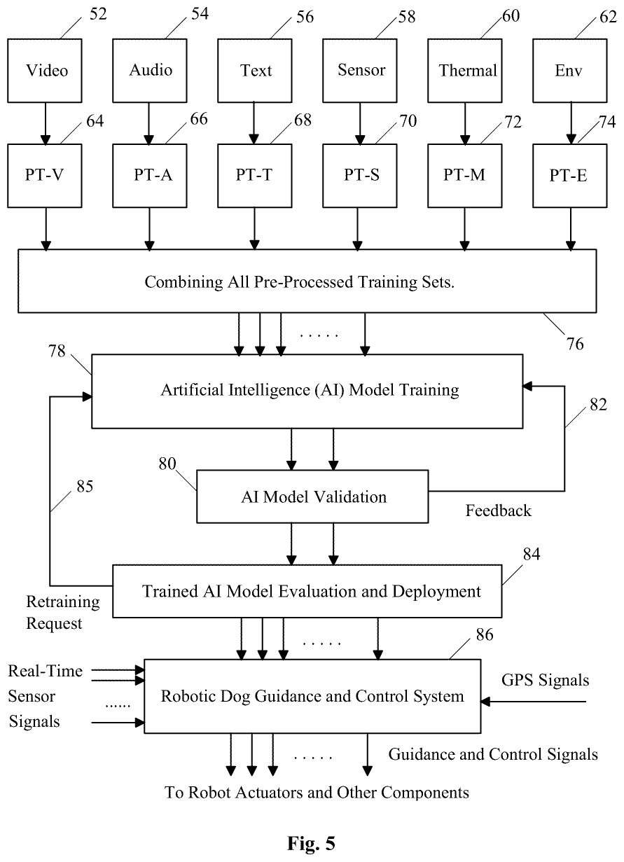

FIG. 5 is a block diagram showing the major components and workflows to develop an artificial intelligence (AI) model to be used in a robotic dog guidance and control system, according to an embodiment of this invention.

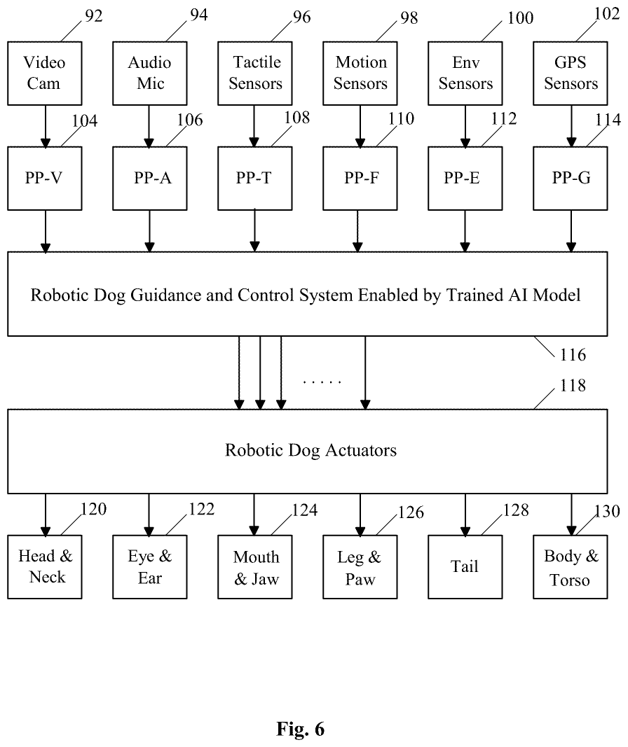

FIG. 6 is a block diagram showing the major components, including sensors, control system, actuators, and signal flows of a robotic dog guidance and control system enabled by a trained AI model, according to an embodiment of this invention.

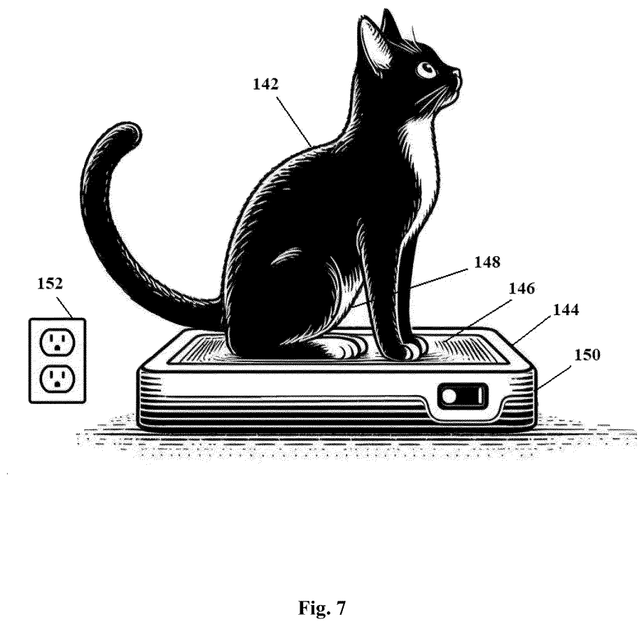

FIG. 7 is a perspective view of a robotic cat standing on a small platform for wireless battery charging, according to an embodiment of this invention.

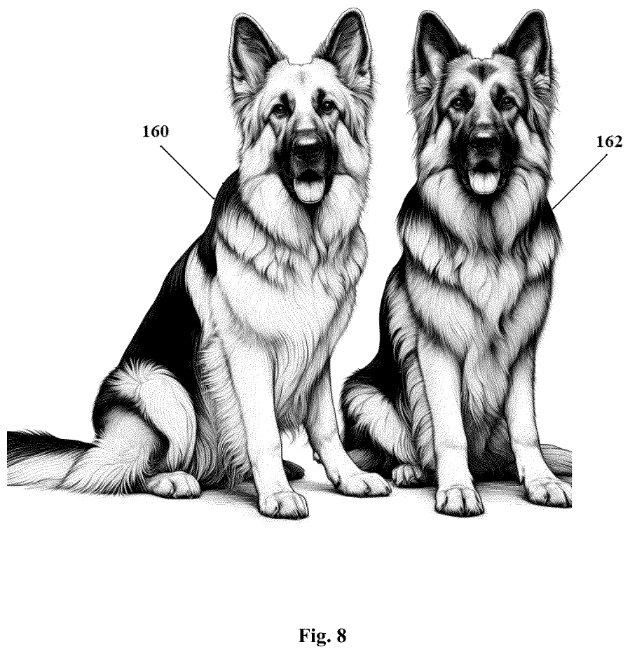

FIG. 8 is a perspective front view of a real dog and a robotic dog with a similar look, wherein the robotic dog can learn and mimic the behaviors of the real dog through continuous online training, according to an embodiment of this invention.

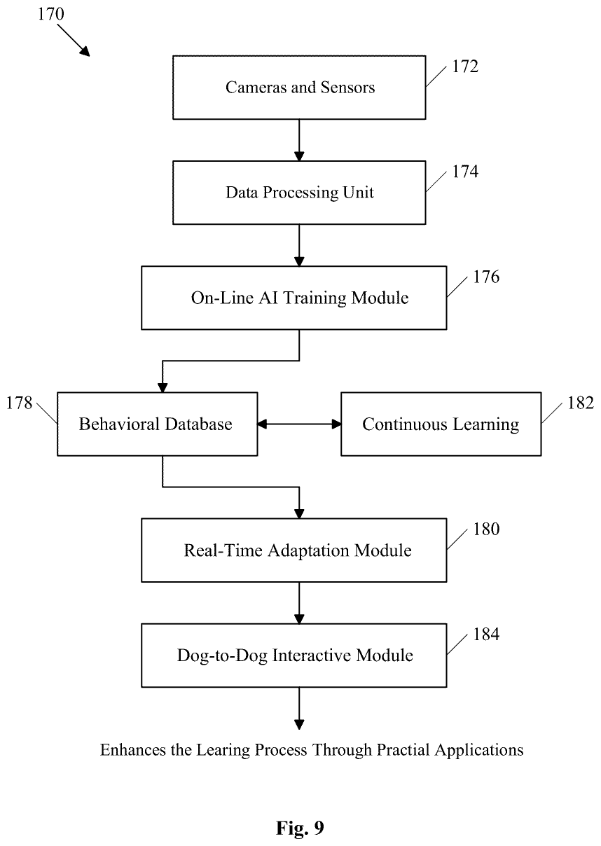

FIG. 9 is a block diagram showing the major components and signal flows of a generative artificial intelligence (AI) based robotic dog online training system, according to an embodiment of this invention.

In this patent, the term “mechanism” is used to represent hardware, software, or any combination thereof. The term “process” is used to represent a physical system or process with inputs and outputs that have dynamic relationships. The term “AI” means artificial intelligence. The term “LLM” means large language model. The term “SLM” means small language model. The term “Gen-AI” means generative AI. The term “GPT” means generative pre-trained transformer. The term “transformer” means a form of artificial neural network model used in generative artificial intelligence. The term “Animal-like robot” means a robot that looks and behaves like an animal. The term “robot” or “robotic” refers to a machine resembling a human being, animal, fish, or insect, capable of replicating certain movements and functions of a human being or other creatures, automatically. The term “a robotic dog” or “a dog robot” means a dog-like robot. The term “a robotic cat” or “a cat robot” means a cat-like robot. The term GPS means Global Positioning System that provides positioning, navigation, and timing services. The term “computing processing unit” or “CPU” means a microprocessor, microcontroller, micro-control unit, or any integrated circuit capable of performing computation and executing software programs and control algorithms.

Without losing generality, a robotic dog or a dog-like robot can also mean a robotic animal or animal-like robot, and vice versa. All numerical values given in this patent are examples. Other values can be used without departing from the spirit or scope of this invention. The description of specific embodiments herein is for demonstration purposes and in no way limits the scope of this disclosure to exclude other not specifically described embodiments of this invention.

### DESCRIPTION

### A. Robotic Service Dog

Service dogs are trained to assist individuals with various disabilities, providing crucial support in daily tasks such as guiding visually impaired people, alerting deaf individuals to sounds, fetching items, and providing physical support for those with mobility issues. Training a service dog is a rigorous and time-consuming process, often taking up to two years of specialized training to ensure the dog can perform its duties reliably and safely. Despite their invaluable assistance, service dogs typically have a lifespan of around 10 years, after which they may need to be retired and replaced. The cost of training a service dog can be substantial, sometimes reaching tens of thousands of dollars. Given these challenges, a robotic dog designed to perform the same functions as a service dog presents a promising market opportunity. A robotic service dog can offer consistent performance, longevity, and potentially lower overall costs, providing a reliable alternative to traditional service dogs and meeting a critical need for many individuals requiring assistance.

FIG. 1 is a perspective front view of a robotic dog with all key components, according to an embodiment of this invention.

The robotic dog (10) comprises a head (12), two eyes (14), a mouth with teeth (16), a nose (18), two ears (20), a neck (22), a body (24), four legs and paws (26), and a tail (28). The robotic dog (10) and its main components are described in the following:

Head (12): The head is designed to mimic the appearance of a real dog, housing various sensory and expressive components. It includes movable parts such as the ears and mouth to provide realistic expressions and functions.

Eyes (14): The eyes are equipped with cameras and other sensors to capture visual data. They enable the robotic dog to navigate its environment, recognize objects and people, and perform vision-based tasks.

Mouth with Teeth (16): The mouth and teeth are designed to mimic the appearance and functions of a real dog's mouth, allowing the robot to grip and interact with objects. The mouth may also have movable parts to simulate barking or other expressions.

Nose (18): The nose includes sensors to detect smells and enhance the robot's environmental awareness. This allows the robotic dog to identify different scents, similar to a real dog.

Ears (20): The ears are equipped with microphones and other sensors to capture audio data. They can move to provide realistic expressions and help the robot detect and locate sounds.

Neck (22): The neck connects the head to the body and provides flexibility and movement, allowing the robotic dog to turn its head and look around. It may contain actuators to enable these movements.

Body (24): The body is designed to resemble the shape and form of a real dog, providing the framework to house and connect all robotic components. It includes spaces for the internal systems such as the power supply, control unit, and sensors.

Legs and Paws (26): The robotic dog has four legs with joints and actuators to replicate the movement and agility of a real dog. The paws are designed to provide stability and grip, allowing the robot to walk, run, and perform various motions.

Tail (28): The tail is equipped with actuators to mimic the movements of a real dog's tail, contributing to balance and expression. It can wag and move to indicate different states or responses.

Each of these components works together to ensure that the robotic dog can perform a wide range of tasks, providing assistance, companionship, and functionality similar to a real dog.

FIG. 2 is a perspective view of a robotic dog working as a service dog to lead a visually impaired person to walk across a busy street, according to an embodiment of this invention. The robotic dog (10) is designed to assist visually impaired individuals by navigating complex environments and ensuring their safety.

The robotic dog (10) is equipped with advanced sensors and AI capabilities to detect obstacles, recognize traffic signals, and determine the safest path. The head (12) includes eyes (14) that function as cameras to capture real-time visual data, while the ears (20) and nose (18) are equipped with auditory and olfactory sensors to gather additional environmental information. The neck (22) provides flexibility, allowing the head to move and adjust its view as needed.

The body (24) houses the central processing unit (CPU) and power supply, while the legs and paws (26) enable smooth and stable movement across various terrains. The tail (28) can be used to communicate the robot's status to the user through specific movements.

The robotic dog (10) uses its AI-driven guidance and control system to process the sensory data, generate guidance and control signals for its motion, and maneuver the person safely through the environment. Additionally, the robotic dog is equipped with a speech recognition system that allows it to understand verbal commands from the user. This system enables the robot to perform tasks as requested by the user, such as stopping, changing direction, or identifying specific objects or locations.

The user holds onto a harness or leash attached to the body (24), allowing the robotic dog to guide them effectively. This embodiment highlights the robot's ability to perform essential tasks typically handled by trained service dogs, offering a reliable and long-lasting alternative to assist visually impaired individuals.

### B. Robotic Dog for Defense and Policy Force Duties

Robotic dogs are becoming increasingly essential in defense and police force duties due to their ability to perform tasks that are dangerous, repetitive, or require a high level of precision. In defense operations, robotic dogs can be deployed to conduct reconnaissance missions, navigate hazardous terrains, and detect explosives or hazardous materials. Their advanced sensors and AI capabilities enable them to gather and relay critical information in real-time, allowing human soldiers to make informed decisions without putting themselves in harm's way. Additionally, robotic dogs can be used for surveillance and perimeter security, providing constant monitoring and alerting personnel to potential threats. Their ability to operate autonomously makes them versatile assets in various military scenarios, enhancing operational efficiency and safety.

In police force duties, robotic dogs can assist in a wide range of tasks, from patrolling urban areas and inspecting suspicious objects to aiding in search and rescue missions. These robots can enter environments that may be too dangerous or inaccessible for human officers, such as collapsed buildings or areas with chemical hazards. Equipped with advanced communication systems, robotic dogs can provide real-time video and audio feeds, allowing officers to assess situations from a safe distance. Moreover, their ability to understand and respond to verbal commands makes them valuable partners in high-stress situations, where quick and accurate responses are crucial. The deployment of robotic dogs in police operations not only enhances the safety and effectiveness of law enforcement personnel but also helps to build trust within the community by demonstrating the use of advanced technology to maintain public safety.

FIG. 3 is a perspective view of a robotic dog supporting defense operations, according to an embodiment of this invention. As a case example, the robotic dog can assist in finding mines. The robotic dog (10) can be equipped with specialized sensors to detect the presence of mines and other explosive devices.

The head (12) includes advanced visual and infrared cameras (14) that allow the robotic dog to survey the area for signs of mines. The nose (18) is fitted with chemical sensors capable of detecting explosive materials, providing an additional layer of safety and accuracy. The ears (20) contain microphones that can pick up subtle sounds of buried mines or devices, enhancing the detection capability.

The body (24) houses a robust CPU and power supply, ensuring that the robotic dog can operate for extended periods in challenging environments. The legs and paws (26) are designed to traverse various terrains, including rough and uneven surfaces commonly found in conflict zones. The tail (28) can signal different statuses or alerts to the human operators, indicating whether a mine has been detected or if the area is clear.

In this embodiment, the robotic dog (10) utilizes its AI-driven guidance and control system to process the data from its sensors, autonomously navigating through the area and marking detected mines for disposal by human operators. This application significantly reduces the risk to human soldiers, allowing them to clear dangerous areas safely and efficiently.

As another case example, the robotic dog can assist in urban warfare scenarios by conducting surveillance and reconnaissance missions in potentially hostile environments. The robotic dog (10) can be equipped with high-definition cameras and night vision capabilities in its eyes (14), allowing it to capture and relay real-time video footage to command centers. The nose (18) can be outfitted with sensors to detect chemical or biological threats, while the ears (20) can pick up distant sounds of enemy movement or communications.

The body (24) can be armored to withstand small arms fire and shrapnel, ensuring the robot's durability in combat situations. The legs and paws (26) are designed for agility, enabling the robotic dog to navigate through rubble, climb stairs, and enter buildings with ease.

In this scenario, the robotic dog (10) uses its AI-driven guidance and control system to autonomously patrol designated areas, identify potential threats, and provide valuable intelligence to military personnel. By operating in high-risk environments, the robotic dog enhances situational awareness and reduces the exposure of human soldiers to danger, thereby improving mission outcomes and overall safety.

For police duties, the robotic dog (10) can assist the police in patrolling urban areas and providing surveillance. Equipped with high-definition cameras and night vision capabilities in its eyes (14), the robotic dog can capture and stream real-time video footage to police command centers, helping officers monitor large areas more efficiently. The nose (18) can be outfitted with sensors to detect narcotics or explosives, enabling the robot to conduct thorough searches during security sweeps or traffic stops. The ears (20) can detect sounds of distress or illegal activities, such as gunshots or breaking glass, alerting officers to potential incidents.

The body (24) houses a robust CPU and communication module, ensuring the robotic dog can process data and maintain constant contact with police networks. The legs and paws (26) are designed for agility, allowing the robotic dog to navigate various terrains, enter buildings, and even climb stairs if necessary. The tail (28) can signal different statuses or alerts to human officers, indicating whether a threat has been detected or if assistance is needed.

In this embodiment, the robotic dog (10) uses its AI-driven guidance and control system to autonomously patrol designated areas, recognize and respond to suspicious activities, and provide valuable intelligence to police officers. This capability significantly enhances situational awareness and allows human officers to focus on critical decision-making and direct intervention when necessary. By operating in high-risk environments and handling routine surveillance tasks, the robotic dog helps to improve overall public safety and efficiency in law enforcement operations.

### C. Robotic Companion Cat

A robotic companion cat is an advanced machine designed to emulate the appearance, behavior, and affectionate nature of a real cat. This innovative technology leverages artificial intelligence and advanced robotics to provide companionship, emotional support, and interactive experiences for individuals of all ages. The robotic companion cat is equipped with lifelike features, such as a realistic fur texture, responsive movements, and expressive behaviors, making it a comforting and engaging presence in any household.

The robotic companion cat can perform a variety of tasks that enhance the well-being and happiness of its owners. It can respond to touch with purring and gentle movements, playfully interact with toys, and follow its owner around the home. The cat can also be programmed to recognize and respond to specific commands, providing an interactive experience that mimics the behavior of a real pet. Additionally, the robotic cat can monitor the environment and provide reminders for medication, hydration, or other health-related tasks, making it a valuable asset for elderly individuals or those with special needs.

The benefits of a robotic companion cat extend beyond simple companionship. For individuals who are unable to care for a real pet due to allergies, physical limitations, or housing restrictions, a robotic cat offers a viable alternative that provides similar emotional benefits without the associated responsibilities. The presence of a robotic companion cat can reduce feelings of loneliness and anxiety, promote relaxation, and improve overall mental health. Furthermore, the cat's ability to engage in playful activities can encourage physical movement and social interaction, contributing to a healthier lifestyle.

FIG. 4 is a perspective front view of a robotic cat with all key components, according to an embodiment of this invention. The robotic cat (30) comprises a head (32), two eyes (34), a mouth with teeth (36), a nose (38), two ears (40), a neck (42), a body (44), four legs and paws (46), and a tail (48). The robotic cat (30) and its main components are described in the following:

Head (32): The head is designed to mimic the appearance of a real cat, housing various sensory and expressive components. It includes movable parts such as the ears and mouth to provide realistic expressions and functions.

Eyes (34): The eyes are equipped with cameras and other sensors to capture visual data. They enable the robotic cat to navigate its environment, recognize objects and people, and perform vision-based tasks.

Mouth with Teeth (36): The mouth and teeth are designed to mimic the appearance and functions of a real cat's mouth, allowing the robot to grip and interact with objects. The mouth may also have movable parts to simulate meowing or other expressions.

Nose (38): The nose includes sensors to detect smells and enhance the robot's environmental awareness. This allows the robotic cat to identify different scents, similar to a real cat.

Ears (40): The ears are equipped with microphones and other sensors to capture audio data. They can move to provide realistic expressions and help the robot detect and locate sounds.

Neck (42): The neck connects the head to the body and provides flexibility and movement, allowing the robotic cat to turn its head and look around. It may contain actuators to enable these movements.

Body (44): The body is designed to resemble the shape and form of a real cat, providing the framework to house and connect all robotic components. It includes spaces for the internal systems such as the power supply, control unit, and sensors.

Legs and Paws (46): The robotic cat has four legs with joints and actuators to replicate the movement and agility of a real cat. The paws are designed to provide stability and grip, allowing the robot to walk, run, and perform various motions.

Tail (48): The tail is equipped with actuators to mimic the movements of a real cat's tail, contributing to balance and expression. It can wag, flick, and move to indicate different states or responses.

Each of these components works together to ensure that the robotic cat can perform a wide range of tasks, providing companionship, interaction, and functionality similar to a real cat.

In summary, the robotic companion cat is a versatile and beneficial addition to any home. Its ability to provide emotional support, interactive companionship, and health monitoring makes it an invaluable tool for improving the quality of life for individuals across various demographics. With its lifelike appearance and behavior, the robotic companion cat offers the joys of pet ownership without the associated challenges, making it a perfect companion for modern living.

### D. Design of Guidance and Control System for Animal-like Robots

Leveraging the advancements in large language models (LLM) and generative artificial intelligence (Gen-AI), we describe an innovative design for Animal-like robots with embodied artificial intelligence. These robots are trained using extensive video, image, and text datasets to perform complex tasks autonomously. In this section, we describe how to design a guidance and control system for robotic dogs with Gen-AI.

FIG. 5 is a block diagram showing the major components and workflows to develop an artificial intelligence (AI) model to be used in a robotic dog guidance and control system, according to an embodiment of this invention. The first layer comprises Video and Image Datasets (52), Audio Datasets (54), Text and Behavioral Annotation Datasets (56), Sensor Signal Datasets (58), Thermal Imaging Datasets (60), and Environmental Data Datasets (62). Each of these datasets are used to provide the following functions:

Video and Image Datasets (52) capture various dog behaviors, action patterns, and interactions with the environment to provide visual context and movement patterns.

Audio Datasets (54) record dog calls, environmental sounds, and other relevant auditory cues to provide auditory context. These datasets help the model understand the soundscape around the dog, which can be crucial for certain behaviors and responses.

Text and Behavioral Annotation Datasets (56) enable the AI model developer to describe scenarios with text in videos, images, audios, sensor data, thermal images, and environmental information. These datasets include detailed instructions on how to respond to specific stimuli and contexts, providing semantic context, detailed explanations of actions, and specific behavioral instructions.

Sensor Signal Datasets (58) contain data from various sensors such as accelerometers, gyroscopes, GPS, and proximity sensors. These datasets provide real-time feedback on the robot's movements, orientation, and interactions with its surroundings, enabling precise control and adaptation to different environments.

Thermal Imaging Datasets (60) contain thermal videos and images that capture the heat signatures of various objects and environments. These datasets help the AI model to understand and interpret thermal data, which is crucial for tasks such as search and rescue, detecting living beings in low-visibility conditions, and monitoring temperature changes in the surroundings.

Environmental Data Datasets (62) contain information about various environmental conditions such as temperature, humidity, air quality, and light levels. These datasets help the AI model understand and adapt to different environmental contexts, ensuring that the robotic dog can operate effectively in diverse conditions and respond appropriately to changes in its surroundings.

All datasets go through a data preparation step to achieve the following goals: (i) Data Cleaning: Removing any irrelevant or noisy data to ensure high-quality inputs; (ii) Data Augmentation: Generating additional training data through techniques such as translation, cropping, or rotating images (if applicable); and (iii) Data Tokenization: Converting raw text into a format suitable for the model, such as tokens or embeddings.

The prepared datasets of video, image, audio, text, sensor, thermal, and environmental information then enter the second layer, which comprises a number of pre-training mechanisms or blocks for pre-training the datasets before they can be used for AI model training. Here, “block” refers to a mechanism that includes hardware, software, or a combination of both to perform specific functions.

Video and Image Datasets (52) enter Pre-training Block PT-V (64), Audio Datasets (54) enter Pre-training Block PT-A (66), Text Datasets (56) enter Pre-training Block PT-T (68), Sensor Datasets (58) enter Pre-training Block PT-S (70), Thermal Imaging Datasets (60) enter Pre-training Block PT-M (72), and Environmental Data Datasets (62) enter Pre-training Block PT-E (74). The pre-training process in each block is designed to clean and prepare the datasets for subsequent AI model training.

The pre-training process typically includes the following steps: (i) Model Initialization: Setting up the model with initial weights, often based on a pre-existing, pre-trained model; (ii) Training on a Large Corpus: Training the model on a large, diverse dataset to learn general language patterns and representations; and (iii) Using Transformers: Implementing transformer architectures, a type of AI neural network widely used in large language model (LLM) training, to efficiently process and generate sequences.

Block (76) combines the cleaned and pre-trained datasets from the individual pre-training blocks. This integration ensures that the datasets are synchronized and formatted appropriately for the next stage of the AI model training process.

The combined datasets then enter Blocks 78 and 80 to perform AI model training and validation. This training process starts with using a commercially available or open-source large language model (LLM) base model. Utilizing such a base model simplifies and streamlines the actual secondary model training and fine-tuning, making the entire process more efficient and manageable. Secondary model training and fine-tuning is the step of adapting the base model to specific tasks by further training it on task-specific datasets. This involves adjusting the model's weights and hyperparameters to optimize its performance for the desired applications.

Neural network weights are the parameters within the model that are adjusted during training to minimize the error in predictions. They determine the strength of the connection between neurons in different layers of the network. Hyperparameters, on the other hand, are the settings that define the overall structure and behavior of the model, such as learning rate, batch size, and the number of layers. These are set before training begins and can significantly impact the model's performance and training efficiency.

The secondary AI model training, fine-tuning, and validation may require substantial computing power and time, involving multiple recurring steps until the model training can be considered complete based on certain model convergence and validation criteria. These steps typically include the following: (i) Task-Specific Training: Training the pre-trained model on a specific dataset tailored to the desired application (e.g., classification, translation); (ii) Adjusting Hyperparameters: Tweaking learning rates, batch sizes, and other parameters to optimize performance for the specific task; and (iii) Validation: Continuously validating the model on a separate validation set to monitor performance and prevent overfitting.

Overfitting means that the model learns the training data too well, including noise and minor details, which negatively impacts its performance on new, unseen data. It results in a model that performs well on the training data but poorly on validation or test data, indicating that it has not generalized well to new situations.

During the Validation (80) step, feedback information is sent back through Step (82) to maintain a continuous relationship between the AI Model Training block (78) and the AI Model Validation block (80). This iterative process ensures that the model training continues until it meets the required model convergence and validation criteria, ensuring robust and accurate performance.

After the AI model is validated, it enters Block 84 for model evaluation and deployment. The evaluation may include: (i) Performance Metrics: Assessing the model using metrics like accuracy, precision, recall, F1 score, and loss to evaluate its effectiveness. The F1 score is a measure of a model's accuracy that considers both precision (the number of true positive results divided by the number of all positive results, including those not identified correctly) and recall (the number of true positive results divided by the number of positives that should have been identified). It is the harmonic mean of precision and recall, providing a single metric that balances both concerns; and (ii) Error Analysis: Analyzing errors and misclassifications to understand model weaknesses and areas for improvement.

The deployment should include: (i) Model Optimization: Compressing and optimizing the model for faster inference and lower resource usage through techniques such as pruning and quantization. Pruning involves removing less important weights in the neural network to reduce its size and complexity, while quantization reduces the precision of the numbers used to represent the model's parameters, making the model smaller and faster without significantly affecting performance; (ii) Integration: Integrating the model into the target application or system to ensure it functions correctly in the intended environment; and (iii) Monitoring and Maintenance: Continuously monitoring the model's performance in real-world scenarios and retraining or updating as necessary to maintain and improve performance. The request for model retraining or updating is shown in Block 85, ensuring that the model remains effective and up-to-date.

All of the steps from gathering datasets to AI model training, validation, and deployment that can be used in this embodiment are any of the known techniques described in the book, “Large Language Models in Action: Design, Build, and Deploy Intelligent LLM Applications” by Liam Sturgis, independently published in April 2024, wherein the book and its contents are herein expressly incorporated by reference in their entirety. All software programs, AI models, and control algorithms are executed using computing processing units (CPU). The term “computing processing unit” or “CPU” means a microprocessor, microcontroller, micro-control unit, or any integrated circuit capable of performing computation and executing software programs and control algorithms.

The trained AI model will be integrated with the Robotic Dog Guidance and Control System (86) to be described in FIG. 6.

FIG. 6 is a block diagram showing the major components, including sensors, control system, actuators, and signal flows of a robotic dog guidance and control system enabled by a trained AI model, according to an embodiment of this invention.

A guidance and control system for a robotic dog is a sophisticated mechanism that directs the robot's movements and actions in real-time. The guidance part involves determining the optimal path and actions for the robot based on inputs from various sensors, such as video cameras, audio microphones, and GPS sensors. This includes processing environmental data to navigate obstacles, adjust motion paths, and execute specific tasks. The control part translates these guidance decisions into precise commands for the actuators, ensuring smooth and accurate movements of the robot's head, legs, tail, and other parts. Together, this system enables the robotic dog to perform complex tasks autonomously and efficiently.

On the first layer of the Robotic Dog Guidance and Control System, it comprises Video Cameras (92), Audio Microphones (94), Tactile Sensors (96), Motion Sensors (98), Environmental Sensors (100), and GPS Sensors (102). The purpose of using these sensors are described in the following:

Video Cameras (92): Capture visual data from the environment to provide real-time video feeds for navigation and analysis.

Audio Microphones (94): Record ambient sounds and audio cues to aid in environmental awareness and communication.

Tactile Sensors (96): Detect physical interactions and contact, providing feedback on touch and pressure.

Motion Sensors (98): Measure motion dynamics such as speed and orientation to ensure stable and controlled motion.

Environmental Sensors (100): Gather data on environmental conditions such as temperature, humidity, and air quality.

GPS Sensors (102): Provide precise location data for navigation and mapping purposes.

Each of these sensors may include specialized hardware and software to process the collected data effectively.

The signals from video cameras (92), audio microphones (94), tactile sensors (96), motion sensors (98), environmental sensors (100), and GPS sensors (102) then enter the second layer of the system. This layer comprises signal pre-processing mechanisms for signal cleanup and validation before they can be used for guidance and control.

As shown in FIG. 6: Video signals (92) enter Preprocessing Block PP-V (104); Audio signals (94) enter Preprocessing Block PP-A (106); Tactile signals (96) enter Preprocessing Block PP-T (108); Motion sensor signals (98) enter Preprocessing Block PP-F (110); Environmental sensor signals (100) enter Preprocessing Block PP-E (112); GPS sensor signals (102) enter Preprocessing Block PP-G (114). Each preprocessing block is responsible for cleaning and validating the respective signals to ensure they are accurate and reliable for the subsequent guidance and control processes.

The output of each preprocessing block then enters the Robotic Dog Guidance and Control System Enabled by Trained AI Model (116) as input signals. This system produces output signals based on guidance and control algorithms in real-time to manipulate the Robotic Dog Actuators (118). These actuators guide and control the motions of various parts of the robotic dog, including: Head and Neck Actuators (120), Eye and Ear Actuators (122), Mouth and Jaw Actuators (124), Leg and Paw Actuators (126), Tail Actuators (128), and Body and Torso Actuators (130). Each of these actuators are described in the following:

Head and Neck Actuators (120): Controls the movement of the head and neck for looking around, nodding, and tilting.

Eye and Ear Actuators (122): Adjusts the position and orientation of the eyes for visual tracking and expression, and moves the ears for auditory directionality and realistic expressions.

Mouth and Jaw Actuators (124): Controls the opening and closing of the mouth for gripping objects or simulating barking.

Leg and Paw Actuators (126): Manages the movement of the legs and paws for walking, running, sitting, standing, and navigating various terrains.

Tail Actuators (128): Controls the motion of the tail for balance, communication, and expressive movements such as wagging.

Body and Torso Actuators (130): Adjusts the position and orientation of the body and torso for tasks requiring bending, twisting, or stabilizing movements.

This real-time guidance and control system ensures that the robotic dog can perform its intended functions effectively and accurately.

### E. Wireless Battery Charging for Animal-Like Robots

Since a robotic dog or cat moves and performs its tasks autonomously without human interaction and remote control, charging the battery inside the robot body becomes a crucial part of the design.

FIG. 7 is a perspective view of a robotic cat standing on a small platform for wireless battery charging, according to an embodiment of this invention.

A wireless battery charging system is designed to charge the robotic cat's battery wirelessly, ensuring it can perform its tasks autonomously without human interaction or remote control. In this system, the robotic cat can simply stand on the battery charger, as illustrated in FIG. 7, which comprises the following components:

Robotic Cat (142): The robotic cat that needs to charge its battery.

Charging Platform (144): A platform designed to accommodate the robotic cat, enabling it to enter into a stable position while charging.

Wireless Charging Coil (146): Embedded within the charging platform, this coil generates an electromagnetic field to transfer energy wirelessly to the robotic cat's battery.

Receiving Coil (148): Integrated within the body of the robotic cat, this coil receives the electromagnetic energy from the charging platform and converts it into electrical energy to charge the battery.

Charging Control Unit (150): A control unit that manages the charging process, ensuring the battery is charged efficiently and safely. It may include features such as overcharge protection and charging status indicators.

The battery charging station should be situated in such a location that the robotic cat or robotic dog can easily enter for resting and charging. The power supply options for the battery charging station include: (i) Grid AC Power: Utilizing existing grid infrastructure to provide consistent electrical power; (ii) Off-Grid Solar Power with Battery Backup: Harnessing solar energy through solar panels, with battery storage to ensure power availability during nighttime or cloudy conditions; (iii) Wind Power with Battery Backup: Generating power through wind turbines, with battery storage to maintain a steady power supply when wind conditions are variable; and (iv) Combination of Grid AC Power, Solar Power, and Wind Power: Integrating multiple power sources to enhance reliability and ensure continuous power availability regardless of environmental conditions. In FIG. 7, an indoor AC power outlet (152) is shown that indicates the battery charging station can be powered by household grid power.

### F. Generative AI-Based Real-Time Robotic Dog Training

Dogs are considered the best friends of humans. Raising and training a companion dog or service dog requires many years of hard work, patience, and love. Dogs generally have a short lifespan, typically 10 to 12 years. When the dog passes away, it really breaks the heart of the owner, and the family feels like they have lost a family member. In this section, we introduce an innovative approach to address this emotional challenge.

A generative AI-based robotic dog can be designed to learn and mimic the behaviors of a real dog through continuous online training by having a real dog and robotic dog live and play together. This approach will provide a seamless transition for families or police forces. The robotic dog will not only serve as a companion but also carry forward the unique characteristics and behaviors of the beloved pet or service dog, offering lasting comfort and companionship.

FIG. 8 is a perspective front view of a real dog and a robotic dog with a similar look, wherein the robotic dog can learn and mimic the behaviors of the real dog through continuous online training, according to an embodiment of this invention.

The real dog (160) has been trained and raised by a human for a few years and can perform tasks as a companion dog or service dog. The robotic dog (162) has all the components and capabilities of the robotic dog (10) described in FIG. 1. When the two dogs live together, the robotic dog (162) can enter an online training mode, allowing it to learn the behaviors and capabilities of the real dog (160).

This approach can be very useful in many application scenarios. A few case examples are presented in the following.

Guide Dog for a Visually Impaired Person. The real dog (160) is a trained guide dog, helping its visually impaired companion navigate safely through various environments. The robotic dog (162) observes the real dog guiding the companion, recognizing obstacles, and responding to commands. Through continuous observation and interaction, the robotic dog learns these critical behaviors. It captures how the real dog stops at curbs, avoids obstacles, and follows specific routes. By processing this information, the robotic dog can replicate these guiding tasks, providing reliable assistance to the visually impaired companion.

Police dog for Detecting Drugs and Arms. The real dog (160) is trained to detect drugs and arms, assisting law enforcement officers in their duties. The robotic dog (162) observes the real dog during training sessions and real-life operations, learning how it identifies and signals the presence of illicit substances and weapons. By capturing live video feeds and sensory data, the robotic dog processes and mimics these detection behaviors. This capability allows the robotic dog to perform similar tasks, enhancing the effectiveness of law enforcement operations and providing a consistent and tireless alternative to real police dogs.

Assisting with Daily Chores. The real dog (160) helps its owner with daily chores such as fetching the newspaper, opening doors, and retrieving items. The robotic dog (162), through continuous observation and interaction, learns these helpful behaviors. It captures how the real dog grabs the newspaper with its mouth, how it pushes down on door handles, and how it selects and brings items to its owner. By processing this information, the robotic dog can replicate these tasks, offering practical assistance to the owner.

These examples demonstrate how the robotic dog can effectively learn and replicate the behaviors of the real dog, providing continuous support, companionship, and assistance in various roles, even after the real dog is no longer present.

FIG. 9 is a block diagram showing the major components and signal flows of a generative artificial intelligence (AI) based robotic dog online training system, according to an embodiment of this invention. The online training system comprises the following main components:

Cameras and Sensors (172): Continuously capture live video and audio data of the behavior of the real dog; and provide the data to the Data Processor Unit (174).

Data Processor Unit (174): Processes live video and audio data in real-time, extracting key behavioral patterns and actions; and provides processed data to the Online AI Training Module (176).

Online AI Training Module (176): Analyzes the processed data to learn the behaviors, movements, and responses of the real dog; and updates the Behavioral Database (178) with new patterns and actions.

Behavioral Database (178): Stores new patterns and actions learned from the real dog; and updates from the Online AI Training Module (176) and provides data to the Real-Time Adaptation Module (180). In addition, it works with the Continuous Learning Module (182) to ensure ongoing updates and improvement.

Real-Time Adaptation Module (180): Allows the robotic dog to implement learned behaviors and adapt in real-time.

Continuous Learning Module (182): Continuously updates the AI model with new data from the real dog's activities. It also works with the Behavioral Database to ensure the AI model keeps evolving.

Interactive Module (184): Facilitates interaction and play between the real dog and the robotic dog; and enhances the learning process through practical application.

These components work together within the generative AI-based online training system (170) to enable the robotic dog to continuously learn and mimic the behaviors of a real dog. The system captures signals through cameras and sensors, processes the data to extract behavioral patterns, updates the AI model with new behaviors, and implements learned behaviors in the robotic dog for real-time adaptation and interaction.

The generative AI-based online training system (170) is seamlessly integrated with all key components of sensors, actuators, the generative AI model, and the robotic dog guidance and control system described in FIGS. 1, 5, and 6 so that this robotic dog (160) can become smarter over time without human interaction. This innovative design ensures that the robotic dog continuously evolves and improves its behavior by learning from the real dog in real-time. The system captures live video and sensory data, processes it to extract key behavioral patterns, and updates the AI model to implement learned behaviors in real-time. This allows the robotic dog to mimic the actions and responses of the real dog accurately, providing a reliable and consistent companion that can perform various tasks with increasing efficiency and intelligence over time.

This innovative approach can be applied on a large scale. For example, a police department requiring 100 K-9 dogs can first train one robotic dog with a well-trained real dog. After training, the AI model in the robotic dog can be copied to 100 other robotic dogs with the same design. This method allows the police department to receive 100 well-trained K-9 dogs simultaneously.

### G. Conclusion

The motivation to develop a robotic dog and an animal-like robot empowered by generative artificial intelligence (Gen-AI) fits the mega-trend of the 4th Industrial Revolution, where everything will be smart. In the not-too-distant future, humanoid robots and robotic creatures will be deployed on a large scale to enhance various sectors, including industrial automation, environmental monitoring, disaster response, wildlife conservation, agriculture, healthcare, and public safety. These advancements will lead to more efficient resource management, quicker emergency responses, better protection of natural habitats, increased industrial and agricultural yields, and improved safety and security in public spaces, profoundly benefiting our society.

The applicant of this patent has many years of experience in technology innovation in industrial automation, renewable energy, and artificial intelligence. Our goal is to contribute to the exciting technology transformation enabled by generative artificial intelligence in various applications that can make a significant impact on our society and the world.

1. A dog-like robot comprising:
a) a body comprising:
(i) a head;
(ii) a plurality of eyes;
(iii) a plurality of ears;
(iv) a nose;
(v) a mouth;
(vi) a body structure to house or connect robot components;
(vii) a plurality of legs with paws; and
(viii) a tail;
b) a plurality of sensors configured to capture environmental data, including at least one video camera and at least one audio microphone;
c) a power supply;
d) a guidance and control system comprising a trained artificial intelligence (AI) model, wherein the guidance and control system is configured to process the environmental data captured by the sensors and generate control signals; and
e) a plurality of actuators responsive to the control signals generated by the guidance and control system, wherein the actuators are configured to manipulate at least the head and legs to perform autonomous walking and task execution.

2. The dog-like robot of claim 1, wherein the plurality of eyes comprises at least one camera and one infrared sensor.

3. The dog-like robot of claim 1, wherein the nose comprises at least one olfactory sensor configured to detect specific scents and odors for detecting drugs, explosives, or other hazardous materials.

4. The dog-like robot of claim 1, wherein the mouth further comprises teeth and a tongue, arranged to mimic the look and biting capabilities of a dog.

5. The dog-like robot of claim 1, wherein the guidance and control system comprises a navigation module configured to use GPS signals for determining the location and path of the robot.

6. The dog-like robot of claim 1, wherein the power supply comprises a battery and a wireless charging system allowing the robot to charge the battery autonomously.

7. The dog-like robot of claim 1, further comprising a speaker configured to produce barking sounds and other vocalizations.

8. A guidance and control system of a dog-like robot, comprising:
a) a plurality of sensors configured to capture environmental data, including at least one video camera and one audio microphone;
b) a trained artificial intelligence (AI) model configured to process the environmental data captured by the sensors and provide robot walking and motion guidance;
c) a computing processing unit configured to execute the AI model, control algorithms, and provide guidance commands and control signals; and
d) a plurality of actuators responsive to the control signals, wherein the actuators are configured to manipulate parts of the dog-like robot to perform autonomous walking and task execution.

9. The guidance and control system of claim 8, wherein the system is configured to perform obstacle detection and avoidance using data from the sensors.

10. The guidance and control system of claim 8, wherein the plurality of sensors further comprises at least one olfactory sensor configured to detect specific scents and odors for detecting drugs, explosives, or other hazardous materials.

11. The guidance and control system of claim 8, wherein the AI model is further configured to allow the robot to bark like a dog.

12. The guidance and control system of claim 8, further comprising a wireless communication module configured to transmit data to, and receive data from, a remote monitoring station.

13. The guidance and control system of claim 8, further comprising a GPS module configured to provide location data for navigation and motion control.

14. The guidance and control system of claim 8, wherein the plurality of actuators are further configured to adjust a head, mouth, ears, legs, and a tail of the dog-like robot to mimic the behavior of a dog.

15. A wireless battery charging system for a dog-like robot or a cat-like robot, comprising:
a) a charging platform configured to accommodate the dog-like robot or cat-like robot in a stable position for charging;
b) a wireless charging coil embedded within the charging platform, configured to generate an electromagnetic field for energy transfer;
c) a receiving coil integrated within the robot, configured to receive the electromagnetic energy from the charging platform and convert it into electrical energy to charge a battery of the robot; and
d) a charging control unit configured to manage the charging process, including monitoring battery status and ensuring safe and efficient energy transfer.

16. The wireless battery charging system of claim 15, wherein the charging control unit is configured to communicate with the dog-like or cat-like robot to provide real-time updates on charging status and battery health.

17. A robotic dog online training system, comprising:
a) a live video capture system configured to capture real-time video feeds of a real dog's behavior;
b) a data processing unit configured to process the captured video data and extract key behavioral patterns and actions;
c) a generative artificial intelligence (AI) model configured to analyze the processed data and learn behaviors, movements, and responses of the real dog;
d) a real-time adaptation system configured to allow the robotic dog to implement learned behaviors and adapt in real-time; and
e) a continuous learning system configured to update the AI model with new data from the real dog's activities.

18. The robotic dog online training system of claim 17 further configured to seamlessly integrate with the guidance and control system of a robotic dog.

19. The robotic dog online training system of claim 17, wherein the real-time adaptation system comprises a feedback mechanism to adjust the robotic dog's behaviors based on real-time interactions and responses from the real dog.

20. The robotic dog online training system of claim 17, wherein the AI model can be saved and copied for use with other robotic dogs to produce more trained robotic dogs.
